(19) United States
(12) Patent Application Publication
(10) Pub. No.: US 2026/0336318 A1
(43) Pub. Date: Oct. 29, 2026

(54) COLOR LOCK

(71) Applicant: THALES DIS FRANCE SAS, MEUDON (FR)

(72) Inventors: Laurent DAVOINE, Rosenau (FR); Christian SAILER, Safenwil (CH)

(73) Assignee: THALES DIS FRANCE SAS, MEUDON (FR)

(21) Appl. No.: 19/106,249

(22) PCT Filed: Aug. 10, 2023
(86) PCT No.: PCT/EP2023/072256

§ 371 Date: Feb. 25, 2025

(30) Foreign Application Priority Data
Aug. 29, 2022 (EP) 22306272.0

(51) Int. Cl. B42D 25/23; B42D 25/24; B42D 25/351; B42D 25/373; B42D 25/378; B42D 25/435

(52) U.S. Cl. CPC B42D 25/23; B42D 25/24; B42D 25/351; B42D 25/373; B42D 25/378; B42D 25/435

(57) ABSTRACT

Provided is a security document that comprises a document body and at least one personalization element comprising at least a first personalization partial element and at least a second personalization partial element being arranged at least partially above one another with respect to an extension direction (E). The first personalization partial element comprises a print and the second personalization partial element is configured to exhibit at least a first appearance (P1) when the security document is viewed under a first viewing angle (α1) and/or when the security document is illuminated under a first illumination angle (β1) and to further exhibit a second appearance (P2) when the security document is viewed under a second viewing angle (α2). Other embodiments disclosed.

### TECHNICAL FIELD

The present invention relates to a security document comprising at least one personalization element according to claim 1 and to a method of producing a security document comprising at least one personalization element according to claim 11.

### BACKGROUND

Security documents such as ID cards and passports generally comprise personalization elements such as an image of the document holder or other holder data such as a name, date of birth, etc. These personalization elements are often provided as a print such as an inkjet print.

Currently, for securing the personalization element against forgery, an overlap of the print (CMY channels) with laser blackening (K channel) is used. However, this solution suffers from the fact that at verification step with bare eyes it cannot be differentiated whether the black part of the print originates from the print or from the laser blackening. Consequently, this “print plus laser” approach cannot be considered as a level one security allowing a verification with bare eyes but only as a level 2 or even level 3 security.

### SUMMARY

It is an object of the present invention to provide a security document comprising at least one personalization element of increased security, preferably of level 1 security.

This object is achieved with the security document according to claim 1. In particular, a security document such as an ID card or a passport is provided, wherein the security document extends along an extension direction and comprises a document body and at least one personalization element. The personalization element comprises at least a first personalization partial element and at least a second personalization partial element. The first personalization partial element and the second personalization partial element are arranged at least partially above one another with respect to the extension direction. In other words, at least a part of the first personalization partial element and at least a part of the second personalization partial element are in alignment along the extension direction. The first personalization partial element comprises a print. The second personalization partial element is configured to exhibit at least a first appearance when the security document is viewed under a first viewing angle and/or when the security document is illuminated under a first illumination angle and to further exhibit a second appearance when the security document is viewed under a second viewing angle and/or when the security document is illuminated under a second illumination angle such, that the personalization element exhibits a first appearance when the security document is viewed under the first viewing angle and/or when the security document is illuminated under the first illumination angle and further exhibits a second appearance when the security document is viewed under the second viewing angle and/or when the security document is illuminated under the second illumination angle.

That is to say, the personalization element as well as the second personalization partial element in each case exhibit a different appearance when the security document is viewed under different viewing angles and/or when the security document is illuminated under different illumination angles. Hence, the first appearance of the second personalization partial element differs from the second appearance of the second personalization partial element and the first appearance of the personalization element differs from the second appearance of the personalization element, respectively. Furthermore, the first viewing angle differs from the second viewing angle and the first illumination angle differs from the second illumination angle, respectively.

The second personalization partial element preferably exhibits its first appearance when the security document is viewed at specular reflection and exhibits its second appearance when the security document is viewed out of specular reflection. Consequently, the personalization element preferably exhibits its first appearance when the security document is viewed at specular reflection and exhibits its second appearance when the security document is viewed out of specular reflection. Being viewed at specular reflection means that the security document is viewed under a viewing angle that corresponds to the illumination angle. Being viewed out of specular reflection means that the security document is viewed under a viewing angle that differs from the illumination angle.

To this end it should be noted that the second personalization partial element and thus the personalization element is preferably configured to exhibit more than two different appearances when the security document is viewed under more than two different viewing angles and/or when the security document is illuminated under more than two illumination angles.

The appearance of the personalization element is preferably provided by the appearance of the first personalization partial element and the appearance of the second personalization partial element. In other words, the appearance of the personalization element can be seen as a superposition of the appearances of the first and second personalization partial elements.

The personalization element particularly preferably corresponds to an image such as a portrait of the holder of the security document. That is, the personalization element preferably is a visual marking. In this case, the first personalization partial element and the second personalization partial element preferably are a first part of the image and a second part of the image, and wherein their superposition provides the image. However, it should be noted that other forms of personalization elements are likewise conceivable. For instance, the personalization element could be an alphanumeric character such as the name of the holder of the security document. That is, the personalization element particularly preferably corresponds to document holder data. However, it should be noted that various sets of alphanumeric data, 1D or 2D bar codes, a personalization for different states, cities, etc. are conceivable as well. Any explanations made herein regarding the personalization element being an image likewise apply to other forms of personalization elements such as the personalization element being an alphanumeric character and vice versa.

The second personalization partial element preferably comprises or consist of a metallic compound and/or an optically variable ink and/or a printed patch and/or a coated patch. The metallic compound preferably is or comprises at least one metallic ink and/or metallic flakes and/or metallic particles. Additionally or alternatively, the second personalization partial element is preferably configured to reflect incident electromagnetic radiation. Additionally or alternatively, the second personalization partial element is preferably configured to be ablated or evaporated or bleached or color-changed upon an irradiation of electromagnetic radiation.

That is to say, the second personalization partial element is preferably configured to exhibit a varying contrast when the security document is viewed under different viewing angles and/or when the security document is illuminated under different illumination angles. In other words, the different appearances of the second personalization partial element mentioned earlier preferably correspond to a varying contrast.

For instance, in the event of the second personalization partial element being a metallic compound that is configured to reflect incident electromagnetic radiation such as ambient light, said varying contrast corresponds to a varying reflectance, wherein the reflectance varies between a metallic or bright appearance and a dark or low-gloss appearance. Likewise, in the event of the second personalization partial element being an optically variable ink (OVI), the appearance of said OVI displays distinct colors depending on the angle viewing angle the security document is viewed at and/or the illumination angle under which the security document is illuminated. In other words, the second personalization partial element exhibits a switch effect.

Since the personalization element comprises the second personalization partial element, said varying contrast or switch effect is observable in the personalization element as well.

Furthermore, the second personalization partial element is preferably configured to be ablated or evaporated or bleached or color-changed upon an irradiation of electromagnetic radiation such as laser radiation. That is, the second personalization partial element is preferably configured to interact with impinging electromagnetic radiation. In the region of impingement of the electromagnetic radiation, the second personalization partial element is preferably ablated or evaporated or bleached or color-changed. As such, it is preferred to initially provide the second personalization partial element in the form of a layer or foil, e.g. an OVI layer or metallic layer or metallic foil that is subsequently selectively irradiated with electromagnetic radiation. Hence, the final second personalization partial element preferably comprises radiation-treated regions and untreated regions. Advantages of the second personalization partial element in the form of the printed patch are a flexibility and cost advantage.

The first personalization partial element preferably corresponds to an inkjet print, a laser print, a thermal transfer print, or a digital print. Additionally or alternatively, the first personalization partial element preferably exhibits an appearance being invariant or essentially invariant under different illumination angles of the security document and/or being invariant or essentially invariant under different viewing angles of the security document. Being “essentially invariant” means that the first personalization partial element can slightly change its appearance such as from shiny to not shiny under different viewing angles or illumination angles, respectively.

The first personalization partial element is preferably a print pattern.

The second personalization partial element is preferably an ablation pattern and/or an evaporation pattern and/or a bleached pattern and/or a color-changed pattern.

The first personalization partial element being a print pattern means that the first personalization partial element comprises one or more areas that do not comprise the print. For instance, the first personalization partial element could comprise one or more areas that are not covered with inkjet. As will be explained in greater detail below, the print preferably comprises CMYK color components. Hence, by way of example each of the CMYK color components can be seen as a binary image (printed pixels (dots) or not printed pixels). Varying the size of the dots or the spacing between the dots enables the generation of different shades of gray (or different shades of Cyan, Magenta and Yellow). That is, the print pattern of the first personalization partial element can be seen as and/or be generated by the known technique being called halftone process.

It is furthermore preferred that the first personalization element does not comprise any holes or the like. The first personalization partial element is particularly preferably provided as a layer, e.g. a print in the form of an ink layer.

The second personalization partial element being at least one of an ablation pattern, an evaporation pattern, a bleached pattern or a color-changed pattern means that the second personalization partial element can comprise holes or the like and/or a changing opacity and/or a changing reflectivity. These holes or the like particularly preferably correspond to the ablations or evaporations mentioned earlier. In this case, the changing opacity is provided by regions of the second personalization partial element being ablated or evaporated and thus being less opaque than non-ablated or non-evaporated regions of the second personalization partial element.

However, said pattern of the second personalization partial element can likewise be provided by a changing opacity that is not related to the removal of material. For instance, in the event of the second personalization partial element being bleached or color-changed upon the irradiation of electromagnetic radiation, said bleached or color-changed regions will remain but have a different opacity than non-bleached or non-color-changed regions. Said second personalization partial element having a changing opacity is preferably present in the event of the personalization element and said second personalization partial element being at least partially provided in a translucent region of the security document. Said translucent region is preferably provided by a transparent region of the document body, see further below.

The second personalization partial element having a changing reflectivity can be present in in any portion of the security document, i.e. translucent or not, but is preferably provided in the event of the personalization element and said second personalization partial element being at least partially provided in an opaque region of the security document. Said opaque region is preferably provided by an opaque region of the document body, see further below.

Said pattern of the second personalization partial element is preferably regular when seen along the transverse direction and preferably has the shape of a grid. Alternatively, said pattern of the second personalization partial element is preferably irregular when seen along the transverse direction.

A regular pattern of the second personalization partial element can be provided by regular spacings between the radiation-treated regions and/or the untreated regions such as regular spacings between the ablations or evaporations or bleachings. Another example of a regular pattern is a same number of radiation-treated regions and/or of the untreated regions. Again another example of a regular pattern is a constant size of the radiation-treated regions and/or the untreated regions, etc.

The pattern in the shape of a grid can be seen as a regular pattern of the radiation-treated regions and/or the untreated regions. For instance, a (fictitious) dot grid could be assigned to the second personalization partial element, and wherein every second dot of the dot grid is radiation-treated such as ablated.

An irregular pattern of the second personalization partial element is preferably provided by means of an irregular arrangement, size or shape of any of the just described aspects. For instance, the irregular pattern of the second personalization partial element could be provided by an irregular grid as in a dithered image and/or by a variable size or shape of the ablations or evaporations or bleachings, etc. The dithered image being for instance a rendered grayscale image from a physical binary image.

The second personalization partial element preferably constitutes a binary image. Alternatively, the second personalization partial element constitutes a grayscale image.

As mentioned earlier, the second personalization partial element is preferably a pattern. To this end it is particularly preferred that said pattern constitutes a binary image, wherein, for instance, every second (fictitious) dot of a dot grid is radiation-treated such as ablated, and wherein every other (fictitious) dot of the dot grid is untreated. As an example, the second personalization partial element can be a metallic layer that is selectively ablated by irradiating electromagnetic radiation onto the metallic layer. The thus created ablations, i.e. the presence and absence of the compound(s) constituting the originally metallic layer, constitute the binary image.

However, it is likewise conceivable that the second personalization partial element constitutes a grayscale image. For instance, the second personalization partial element could comprise a range of opacities and/or range of reflectivity and/or a range of colors that can be tuned using different radiation energy of the electromagnetic radiation being irradiated onto the second personalization element, for instance. To this end it is particularly preferred that the second personalization partial element constituting the grayscale image is associated with pixels that contain several shades of grey. Such a physical grayscale pixel (also called continuous tone image) can comprise various shades of grey per pixel. Such a second personalization partial element could be realized by different range of opacities or range of reflectivity per pixel that could in turn be generated by tuning the power of the electromagnetic radiation being irradiated onto the second personalization partial element. For example, the second personalization partial element could be generated with different power levels used per pixel leading to different sizes of ablated holes (varying level of light let through for example per pixel) thus creating a gray scale image. Similarly and alternatively if one does not ablate holes the effect on e.g. an optically variable ink could depend on the power used per pixel and the resulting change in appearance could vary proportionally to this power again leading to gray scale image.

This is in contrast to the physical binary pixel (also called half tones image), wherein only two states per pixel are possible such as bright or dark. However, in this latter case it should be noted that it is nevertheless possible that the second personalization partial element provides a rendering grayscale image using a dithered image or halftone image.

The second personalization partial element preferably constitutes a positive part of the personalization element. Alternatively, the second personalization partial element constitutes a negative part of the personalization element.

The second personalization partial element constituting the positive part of the personalization element means that dark or black components in the appearance of the personalization element are removed from the second personalization partial element.

The second personalization partial element constituting the negative part of the personalization element means that bright or white components in the appearance of the personalization element are removed from the second personalization partial element.

For instance, in the event of the personalization element being an image, the second personalization partial element constituting the positive part can be seen as a positive image part and the second personalization partial element constituting the negative part can be seen as a negative image part. As an example, it is assumed that the second personalization partial element is a metallic component such as a metallic layer that is selectively laser ablated. Hence, in the former case a positive laser ablation is performed, wherein the dark or black components of the image are ablated, and in the later case a negative ablation is performed, wherein the bright or white part of the image are ablated.

The personalization element preferably comprises CMYK color components. Furthermore, the first personalization partial element preferably provides at least one of the CMYK color components. Furthermore, the second personalization partial element preferably provides at least one of the CMYK color component such as the K component.

That is, the personalization element preferably is a coloured personalization element.

The personalization element can comprise all CMYK color components. However, it is likewise conceivable that the personalization element comprises at least one of the CMY color components, for instance just one color component such as the C color component, and additionally the K color component. In this case, the C color component is preferably provided by the first personalization partial element and the K color component is provided by the second personalization partial element.

The K color component being provided by the second personalization partial element preferably corresponds to an untreated region of the second personalization partial element. In other words, the K color component provided by the second personalization partial element preferably is at least one metallic compound and/or an optically variable ink and/or configured to reflect incident electromagnetic radiation as mentioned above. Again in other words, the K component provided by the second personalization partial element preferably corresponds to a non-ablated and/or non-evaporated and/or non-bleached and/or non-color-changed region of the second personalization partial element.

However, it should be noted that the second personalization partial element must not in any case provide the K component but can provide at least one of the CMY color components as well. That is, the second personalization partial element can not only be reflective or only opaque but can contribute with at least one color as well. In this latter case, the first personalization partial element and the second personalization partial element are preferably complementing each other to a full color personalization element.

The first personalization partial element is preferably provided on a surface of the document body and the second personalization partial element is preferably provided within the document body.

The first personalization partial element thus preferably corresponds to a surface print.

Moreover, the first personalization partial element is preferably arranged before the second personalization partial element with respect to the extension direction.

The document body preferably corresponds to a document body as it is known in the field of the security documents. That is, the document body preferably comprises one or more layers being arranged above one another with respect to the extension direction, and wherein said one or more layers preferably comprise or consist of polymers and/or plastics, preferably thermoplastics, particularly preferably polycarbonate and/or polyvinyl chloride and/or polyethylene terephthalate. One or more of these layers can be transparent or non-transparent, i.e. opaque.

Two or more layers of the document body are preferably laminated to one another as it is known in the field of the art.

The first personalization partial element is preferably directly printed onto a surface of an uppermost layer of the document body.

The second personalization partial element can be provided on a surface of one of the layers of the document body. For instance, in the event of the second personalization partial element being an ink such as an optically variable ink or a metallic ink, said ink can be printed onto the surface of one of the layers of the document body, and wherein said layer is subsequently connected to other layers of the document body. However, it is likewise conceivable that the second personalization partial element is provided as a layer or foil, e.g. an OVI layer or metallic layer or metallic foil, that is arranged between two layers of the document body, and wherein these layers are subsequently connected to one another.

The document body preferably comprises at least one transparent region, and wherein the personalization element is at least partially arranged in the transparent region. Additionally or alternatively, the document body preferably comprises at least one opaque region, and wherein the personalization element is at least partially arranged in the opaque region and before the opaque region with respect to the extension direction.

The transparent region of the document body preferably corresponds to one or more transparent layers of the document body or parts thereof.

The opaque region of the document body preferably corresponds to one or more opaque layers of the document body or parts thereof.

The transparent region of the document body is also known as a window in the field of the art. Hence, the personalization element being arranged in the transparent region of the document body corresponds to a personalization element being arranged in a window.

The appearance of the second personalization partial element and thus the appearance of the personalisation element depends on the second personalization partial element being a negative part or a positive part as well as on whether or not the personalization element is arranged in a transparent region (window) or before an opaque region (non-window) of the document body with respect to the extension direction.

For instance, in the event of the second personalization partial element being a metallic layer that is selectively ablated so as to form part of an image, the layer below the metallic layer is visible through the ablation. Depending on whether said layer is transparent or opaque, the part of the image formed in the metallic layer is optimally visible in see-through of the security document (in case of transparent layer or window) or in plan view of the security document (in case of opaque layer or non-window). Furthermore, owing to the reflection behaviour of the metallic layer, this gives rise to several appearances of the personalization element when the security document is viewed under different viewing angles and/or under different illumination angles.

For illustrative purposes different examples are presented in the following.

Example 1 concerns a second personalization partial element comprising positive ablations, and wherein the personalization element is arranged in a non-windowed security document. Because of the non-windowed security document a top side of the security document is illuminated. In this case, the second personalization partial element appears bright in plan view of the security document and dark when viewed under a viewing angle being different from 90° with respect to a top surface of the security document.

Example 2 concerns a second personalization partial element comprising negative ablations, and wherein the personalization element is arranged in a non-windowed security document. Because of the non-windowed security document a top side of the security document is illuminated. In this case, the second personalization partial element appears dark in plan view of the security document and bright when viewed under a viewing angle being different from 90° with respect to the top surface of the security document.

Example 3 concerns a second personalization partial element comprising positive ablations, and wherein the personalization element is arranged in a windowed security document. In the event that a topside of the security document is illuminated, the second personalization partial element appears dark in plan view of the security document. In the event that the bottomside of the security document is illuminated, the second personalization partial element appears bright in plan view of the security document (since the illuminating light is allowed to shine through the ablated second personalization partial element).

Example 4 concerns a second personalization partial element comprising negative ablations, and wherein the personalization element is arranged in a windowed security document. In the event that a topside of the security document is illuminated, the second personalization partial element appears bright in plan view of the security document. In the event that the bottomside of the security document is illuminated, the second personalization partial element appears dark or low-glossy in plan view of the security document (since the illuminating light is allowed to shine through the ablated second personalization partial element).

In another aspect, a method of producing a security document such as an ID card or a passport extending along an extension direction is provided. The security document preferably corresponds to the security document as described above. As such, any statements made herein regarding the security document per se preferably likewise correspond to the method and vice versa. The method comprises the steps of i) providing a document body, and ii) providing at least one personalization element. The personalization element comprises at least a first personalization partial element and at least a second personalization partial element. The first personalization partial element and the second personalization partial element are arranged at least partially above one another with respect to the extension direction. In other words, at least a part of the first personalization partial element and at least a part of the second personalization partial element are in alignment along the extension direction. The first personalization partial element comprises a print. The second personalization partial element is configured to exhibit at least a first appearance when the security document is viewed under a first viewing angle and/or when the security document is illuminated under a first illumination angle and to further exhibit a second appearance when the security document is viewed under a second viewing angle and/or when the security document is illuminated under a second illumination angle such, that the personalization element exhibits a first appearance when the security document is viewed under the first viewing angle and/or when the security document is illuminated under the first illumination angle and further exhibits a second appearance when the security document is viewed under the second viewing angle and/or when the security document is illuminated under the second illumination angle.

The second personalization partial element is preferably provided as a layer or foil or a printed patch or a coated patch. Furthermore, the second personalization partial element preferably comprises or consists of at least metallic compound and/or an optically variable ink.

Electromagnetic radiation such as laser radiation is preferably irradiated onto the second personalization partial element, whereby one or more radiation-treated regions are generated in the second personalization partial element. Said radiation-treated regions particularly preferably are ablations or evaporations or bleachings or color-changes.

The first personalization partial element is preferably inkjet printed, laser printed, thermal transfer printed, or digitally printed. Additionally or alternatively, the first personalization partial element is preferably printed on a surface of the document body. Additionally or alternatively, the second personalization partial element is preferably generated by irradiating electromagnetic radiation.

It is furthermore preferred that electromagnetic radiation of varying power is irradiated onto the second personalization partial element. As mentioned earlier, this allows the generation of a second personalization partial element in the form of a physical grayscale pixel that comprises various shades of grey per pixel. For instance, the irradiation of different power levels per pixel leads to different sizes of ablated holes such that varying level of light is let through for example per pixel and thus creates a gray scale image. Likewise, the irradiation of different power levels per pixel can on a second personalization partial element in the form of an optically variable ink can result in a change in appearance that varies proportionally to this power and thus again leads to a gray scale image.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1a shows a sectional view of a security document comprising a personalization element having an inkjet layer and a metal layer as well as an opaque layer,

FIG. 1b shows a sectional view of the security document according to FIG. 1a after partial ablation of the metallic layer,

FIG. 2 shows a sectional view of a transparent security document comprising a personalization element having an inkjet layer and a partially ablated metal layer,

FIG. 3 shows a sectional view of a security document comprising a personalization element having an inkjet layer and a metal layer that are located in a transparent region of the security document,

FIG. 4a shows a sectional view of the security document according to FIG. 1b being viewed at specular reflection,

FIG. 4b shows a sectional view of the security document according to FIG. 1b viewed out of specular reflection,

FIG. 5a shows a personalization element being positively laser ablated and being viewed at specular reflection,

FIG. 5b shows the personalization element according to FIG. 5a being viewed out of specular reflection,

FIG. 6a shows a personalization element being negatively laser ablated and being viewed at specular reflection,

FIG. 6b shows the personalization element according to FIG. 6a being viewed out of specular reflection,

FIG. 7a shows a sectional view of the security document according to FIG. 1b being viewed at specular reflection,

FIG. 7b shows a sectional view of the security document according to FIG. 1b being viewed out of specular reflection,

FIG. 8a shows a security document having a personalization element being positively laser ablated and being viewed at specular reflection,

FIG. 8b shows the security document according to FIG. 8a being viewed out of specular reflection,

FIG. 9a shows a security document comprising a personalization element being negatively laser ablated and being viewed at specular reflection,

FIG. 9b shows the security document according to FIG. 9a being viewed out of specular reflection,

FIG. 10a shows a security document comprising a personalization element being positively laser ablated and being viewed at specular reflection,

FIG. 10b shows the security document according to FIG. 10a and being viewed in transmission,

FIG. 11a shows a security document comprising a personalization element being negatively laser ablated and being viewed at specular reflection,

FIG. 11b shows the security document according to FIG. 11a and being viewed in transmission.

### DETAILED DESCRIPTION

Various aspects of a security document 1 according to the invention shall now be discussed with respect to the figures.

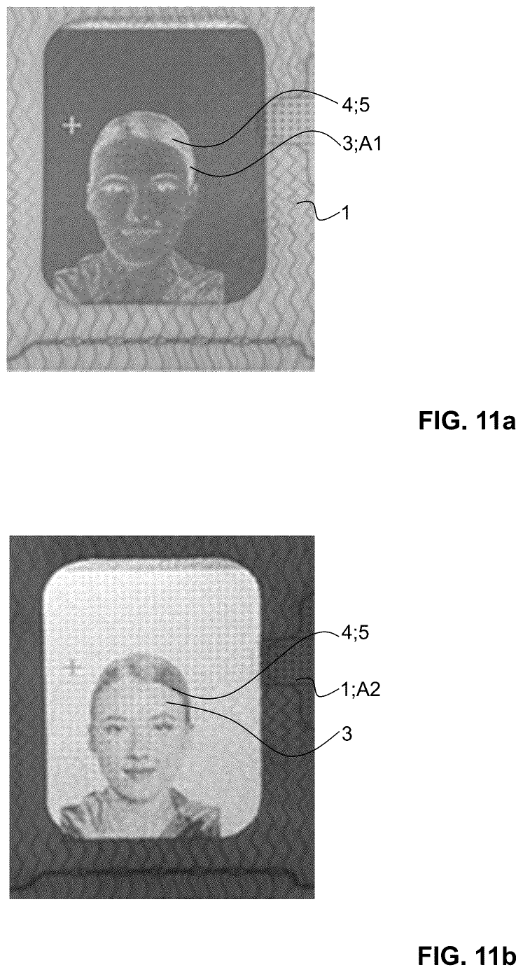

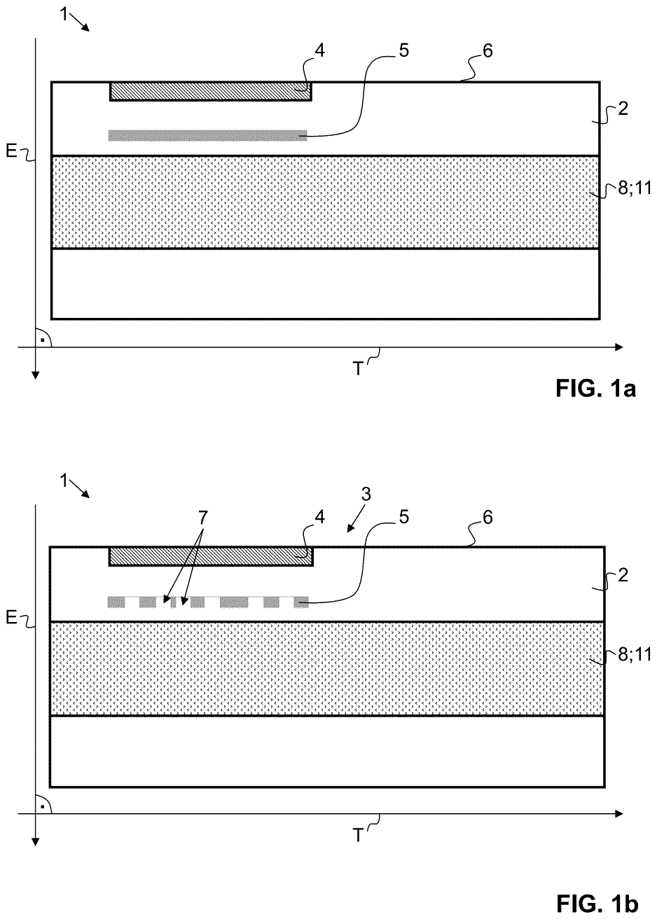

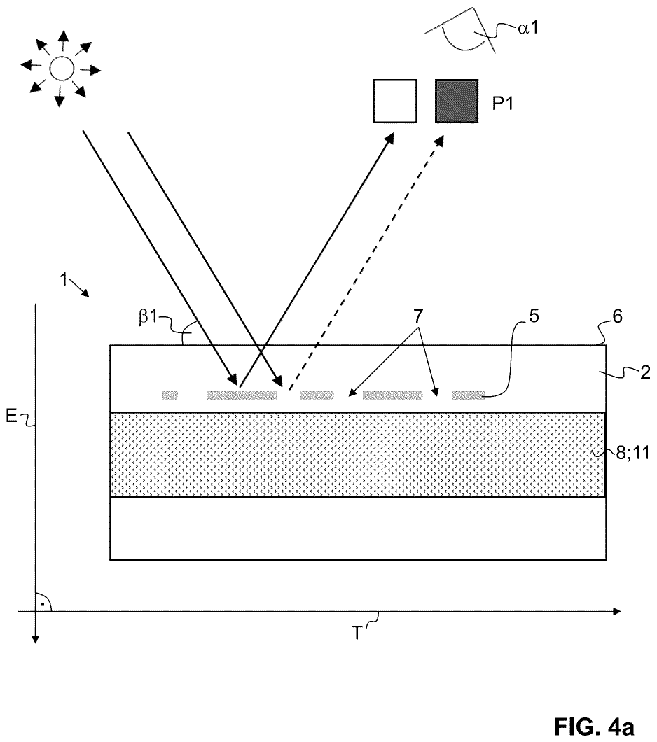

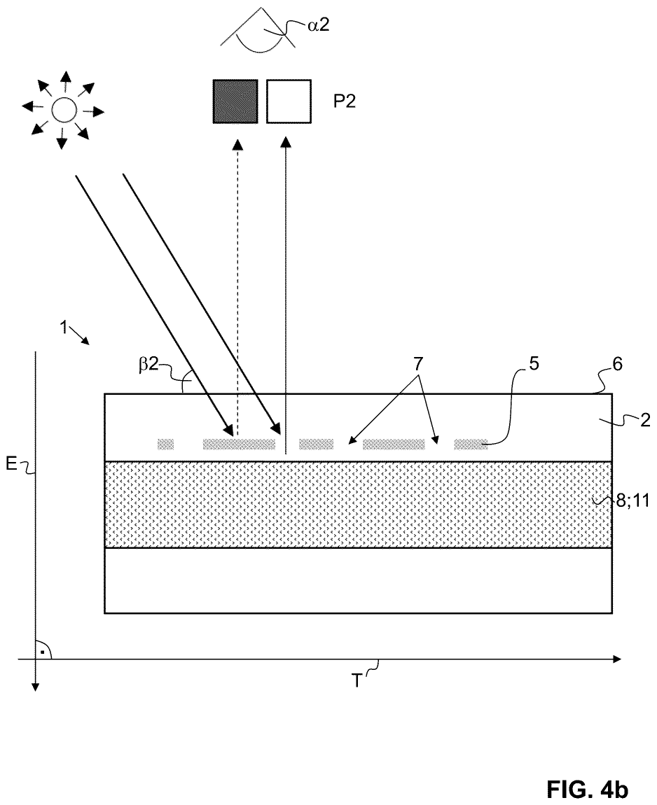

As follows from FIGS. 1a-3 and 7a-7b, the security document 1 extends along an extension direction E and comprises a document body 2 and at least one personalization element 3. The personalization element 3 comprises at least a first personalization partial element 4 and at least a second personalization partial element 5, wherein the first personalization partial element 4 is at least partially arranged before the second personalization partial element 5 with respect to the extension direction E. The first personalization partial element 4 consists of a print and is provided on a surface 6 of the document body 2. The second personalization partial element 5 is provided within the document body 2 and corresponds in the depicted example to a metallic foil that can be laser ablated. In FIG. 1a, the second personalization partial element 5 is untreated, i.e. no laser radiation has been irradiated onto the second personalization partial element 5 yet. In the other figures, the second personalization partial element 5 has been treated, i.e. laser radiation has been irradiated onto the second personalization partial element 5 so as to generate radiation-treated regions 7. These radiation-treated regions 7 correspond here to laser ablations being generated in the metallic foil. The first personalization partial element 4 exhibits an appearance P0 being invariant under different illumination angles of the security document 1 and being invariant under different viewing angles of the security document. The second personalization partial element 5 being a metallic foil however is configured to reflect incident electromagnetic radiation and is hence configured to exhibit at least a first appearance P1 when the security document 1 is viewed under a first viewing angle α1 and/or when the security document 1 is illuminated under a first illumination angle β1 and to further exhibit a second appearance P2 when the security document 1 is viewed under a second viewing angle α2 and/or when the security document 1 is illuminated under a second illumination angle β2, see FIGS. 4a and 4b. Consequently, the personalization element 3 exhibits a first appearance A1 when the security document 1 is viewed under the first viewing angle α1 and/or when the security document 1 is illuminated under the first illumination angle β1 and further exhibits a second appearance A2 when the security document 1 is viewed under the second viewing angle α2 and/or when the security document 1 is illuminated under the second illumination angle β2.

As furthermore follows from FIGS. 1a-3 and 7a-7b, the first personalization partial element 4 is regular when seen along a transverse direction T extending perpendicularly to the extension direction E. Whereas the second personalization partial element 5 is regular before its treatment (see FIG. 1a), it is irregular after its treatment. In fact, in the depicted examples a size, a shape and a spacing of the laser ablations 7 differs with respect to the transverse direction T.

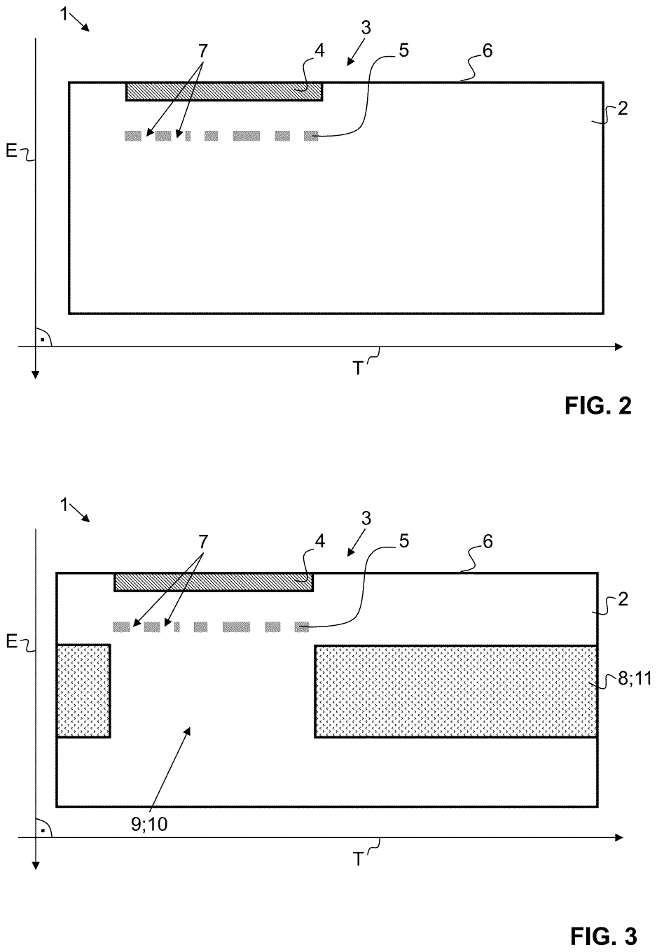

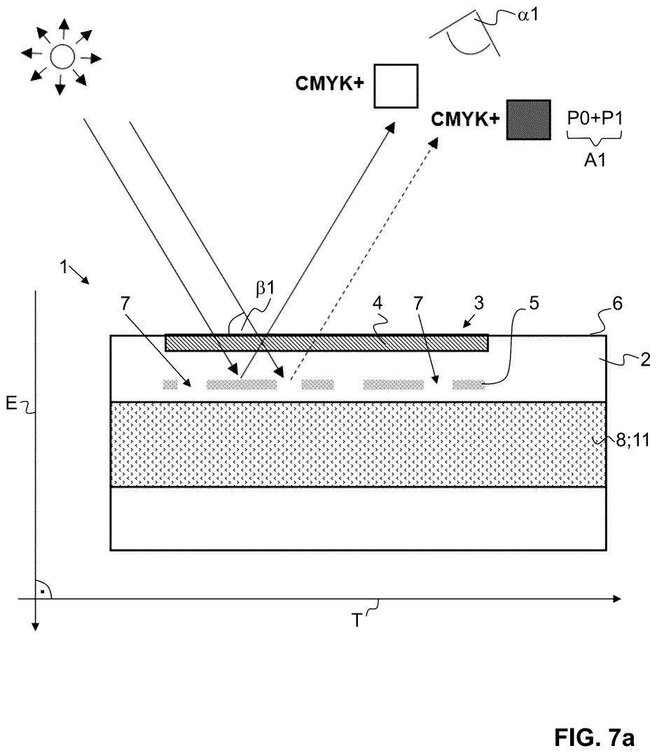

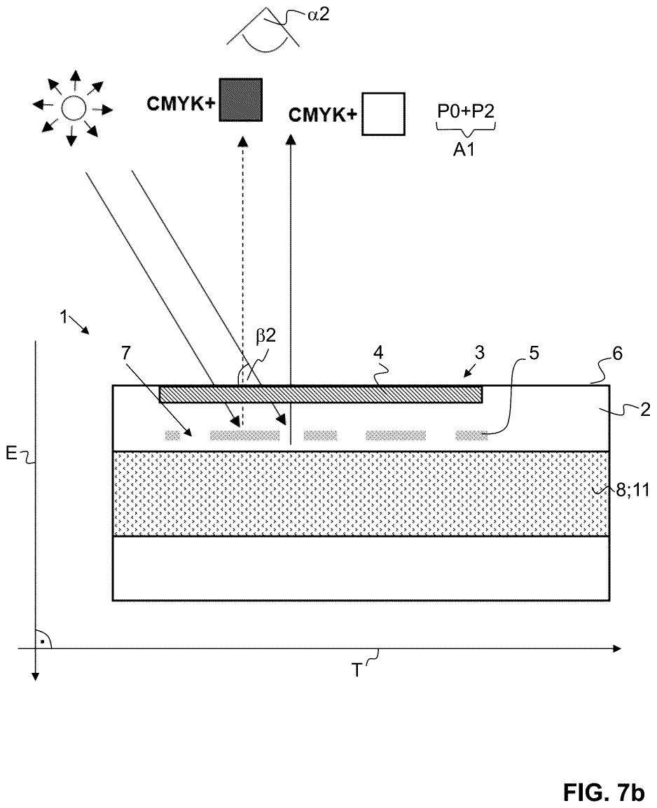

In the depicted examples, the document body 2 is provided by several layers that are arranged above one another with respect to the extension direction E. Said layers consist of polymers and/or plastics, preferably thermoplastics that can be transparent or non-transparent, i.e. opaque. FIG. 2 depicts a security document 1 comprising an entirely transparent document body 2. FIGS. 1a-1b, 3-4b and 7a-7b depict a security document 1 having with a document body 2 that comprises an opaque layer 8. Whereas the opaque layer 8 extends entirely along the transverse direction T in FIGS. 1a-1b, 4a-4b and 7a-7b, the opaque layer 8 of the document body 2 depicted in FIG. 3 is intermittent. That is, FIG. 3 depicts a security document 1 comprising a so-called window 9. Hence, the document body 2 can be said to comprise at least one transparent region 10, and wherein the personalization element 3 is at least partially arranged in the transparent region 9, 10, see FIGS. 2-3. FIGS. 1a-1b and 7a-7b however comprise a document body 2 that has at least one opaque region 11, and wherein the personalization element 3 is at least partially arranged in the opaque region 11 and before the opaque region 11 with respect to the extension direction E. Moreover, whereas the first personalization partial element 4 is printed onto the surface 6 of an uppermost layer of the document body 2, the second personalization partial element 5 is provided between layers of the document body 2.

In the depicted examples, the personalization element 3 is a colored personalization element comprising CMYK color components. Here, at least one of the CMYK color components is provided by the first personalization partial element 4 being a color print, whereas the second personalization partial element 5 provides the K component. To this end it is preferred to treat the second personalization partial element 5 such that it constitutes a binary image or a grayscale image after its treatment, here after being selectively laser ablated. Furthermore, the second personalization partial element 5 can be treated such that it constitutes a positive part of the personalization element 3 or a negative part of the personalization element 3.

The above aspects of the first personalization partial element 4 and the second personalization partial element 5 enable the generation of a personalization element 3 that exhibits different appearances A1, A2 when the security document 1 is viewed under different viewing angles α1, α2 and/or when the security document 1 is illuminated under different illumination angles β1, β2. These will be illustrated now with reference to FIGS. 4a to 11b.

In fact, FIG. 4a illustrates a sectional view of a security document 1 according to FIG. 1b (wherein the first personalization partial element has been omitted) viewed under a first viewing angle α1 being here at specular reflection. The second personalization partial element 5 in the form of the laser-treated regions 7, i.e. the ablated metallic regions, appears dark while the remaining untreated metallic regions appear bright making the second personalization partial element appear with a first appearance P1.

FIG. 4b shows a sectional view of the document according to FIG. 1b (wherein the first personalization partial element has been omitted) viewed under a second viewing angle α2 being here out of specular reflection. The laser-treated regions 7 in the form of the ablated metallic regions of the second personalization partial element 5 appears bright while the remaining metallic regions appear dark making the second personalization partial element appear with a second appearance P2.

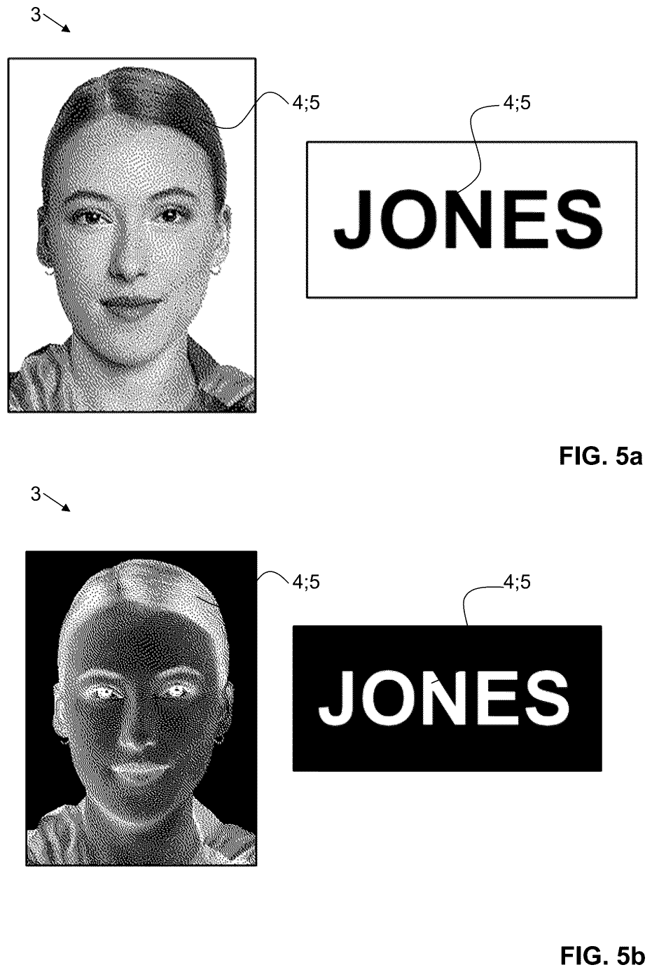

FIG. 5a illustrates the appearance A1 of a personalization element 3 being viewed under the first viewing angle α1 being here at specular reflection, wherein the second personalization partial element 5 is provided by laser-treated regions 7 and non-treated regions in the form of a positive laser ablation in a metallic foil (portrait and text), and wherein the dark or black appearance A1 of the personalization element 3 in the form of an image are the laser-ablated regions 7.

FIG. 5b illustrates the appearance A2 of the personalization element 3 being viewed under the second viewing angle α2 being here out of specular reflection, wherein the second personalization partial element 5 is provided by the positive laser ablation in the metallic foil (portrait and text), wherein the dark or black appearance A2 of the personalization element 3 are the laser-ablated regions 7.

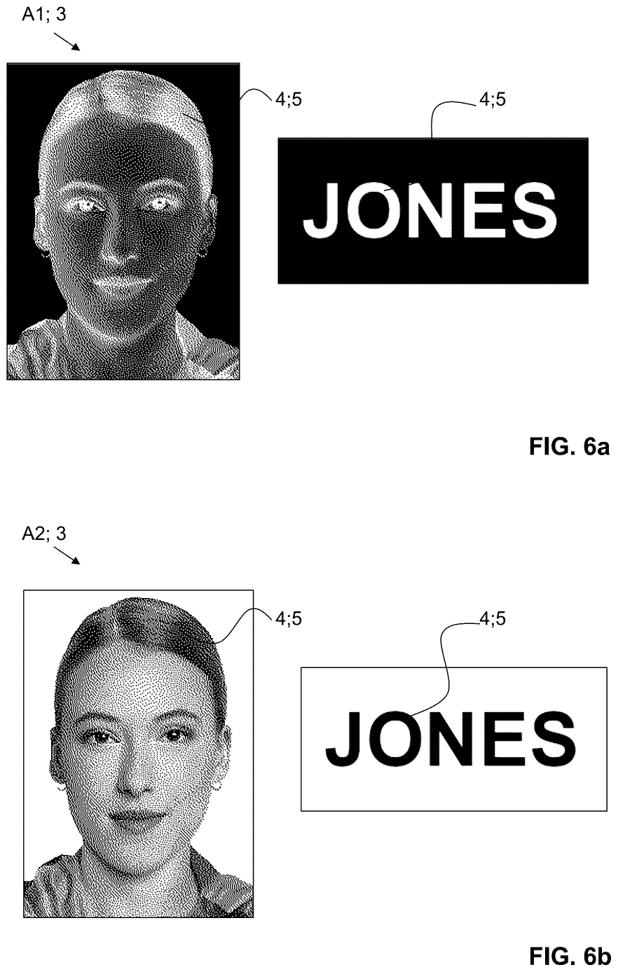

FIG. 6a illustrates the appearance A1 of a personalization element 3 being viewed under the first viewing angle being here at specular reflection, wherein the second personalization partial element 5 is provided by a negative laser ablation in a metallic foil (portrait and text), wherein the bright or white appearance A1 of the personalization element 3 are the laser-ablated regions 7.

FIG. 6b illustrates the appearance A2 of the personalisation element 3 being viewed under the second viewing angle being here out of specular reflection, wherein the second personalization partial element 5 is provided by a positive laser ablation in a metallic foil (portrait and text), wherein the bright or white part of the personalization element 3 are the laser-ablated regions 7.

FIG. 7a illustrates the appearance A1 of the security document 1 according to FIG. 1b viewed under a first viewing angle α1 being here at specular reflection. The appearance A1 of the personalization element 3 is a superposition of the appearance P0 of the first personalization partial element 4 in the form of an inkjet layer and the appearance P1 of the second personalization partial element 5 in the form of a metallic layer. The ablated metallic regions 7 appear dark while the remaining metallic regions appear bright.

FIG. 7b illustrates the appearance A2 of the security document 1 according to FIG. 1b viewed under a second viewing angle being here out of specular reflection. The appearance A2 of the personalization element 3 is a superposition of the appearance P0 of the first personalization partial element 4 in the form of the inkjet layer and the appearance P2 of the second personalization partial element 5 in the form of the metallic layer. The ablated metallic regions 7 appear bright while the remaining metallic regions appear dark.

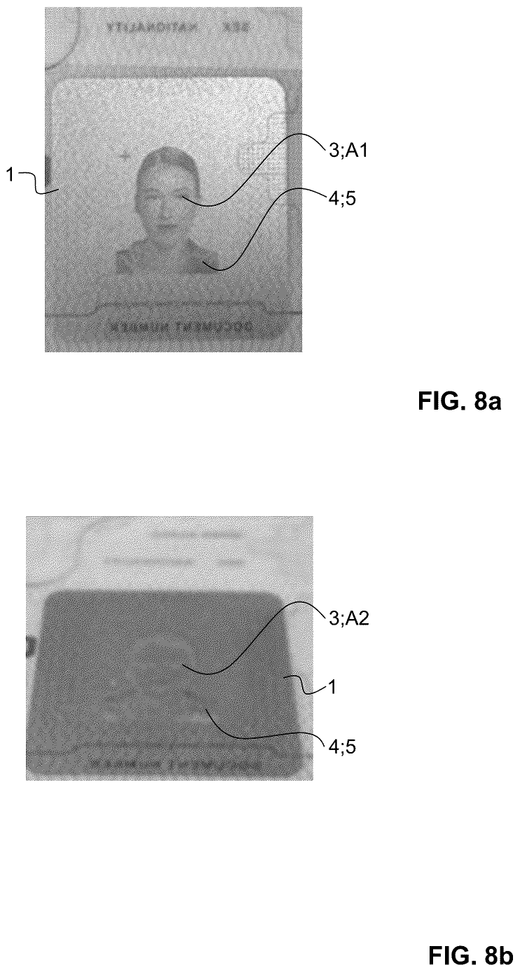

FIG. 8a illustrates the appearance A1 of the security document 1 according to FIG. 1b viewed under the first viewing angle being here at specular reflection in case of the second personalization partial element 5 being a positive laser ablation. The ablated metallic regions 7 appear dark while the remaining metallic regions appear bright.

FIG. 8b illustrates the appearance A2 of the security document 1 according to FIG. 1b viewed under the second viewing angle being here out of specular reflection in case of the second personalization partial element 5 being a positive laser ablation. The ablated metallic regions 7 appear bright while the remaining metallic regions appear dark.

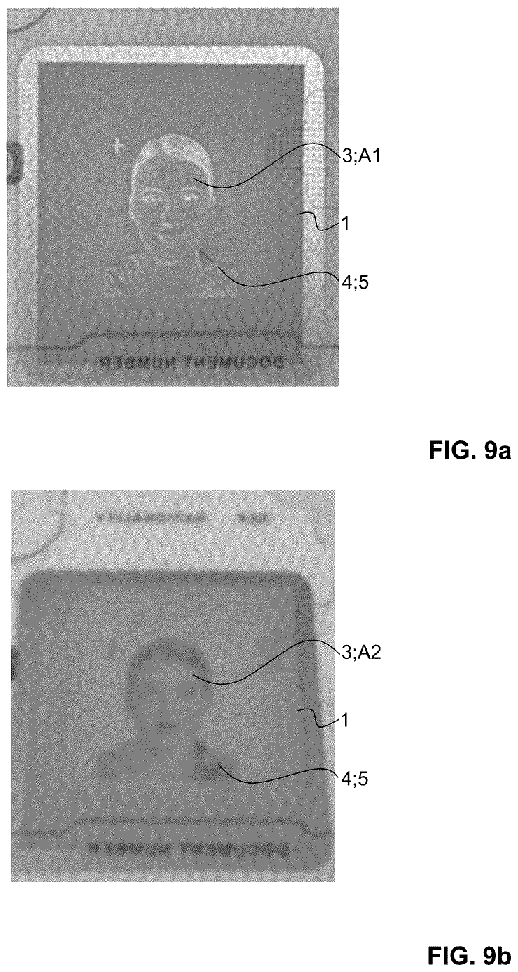

FIG. 9a illustrates the appearance A1 of the security document 1 according to FIG. 1b viewed under the first viewing angle being here at specular reflection in case of the second personalization partial element 5 being a negative laser ablation. The ablated metallic regions 7 appear dark while the remaining metallic regions appear bright.

FIG. 9b illustrates the appearance A2 of the security document 1 according to FIG. 1b viewed under the second viewing angle being here out of specular reflection in case of the second personalization partial element 5 being a negative laser ablation. The ablated metallic regions 7 appear bright while the remaining metallic regions appear dark.

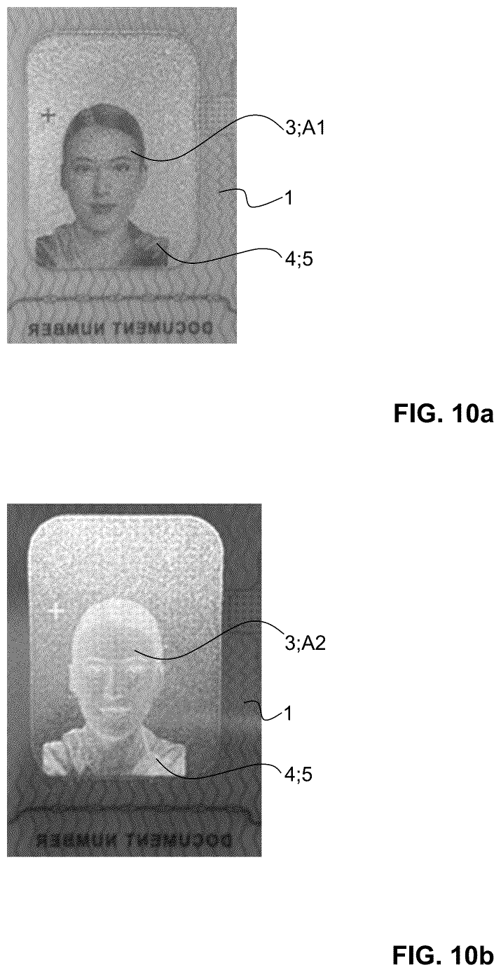

FIG. 10a illustrates the appearance A1 of the security document 1 according to FIG. 3 viewed under the first viewing angle being here at specular reflection in case of the second personalization partial element 5 being a positive laser ablation. The ablated metallic regions 7 appear dark while the remaining metallic regions appear bright.

FIG. 10b illustrates the appearance A2 of the security document 1 according to FIG. 3 viewed under a first illumination angle being here in transmission in case of the second personalization partial element 5 being a positive laser ablation. The ablated metallic regions 7 appear bright while the remaining metallic regions appear dark.

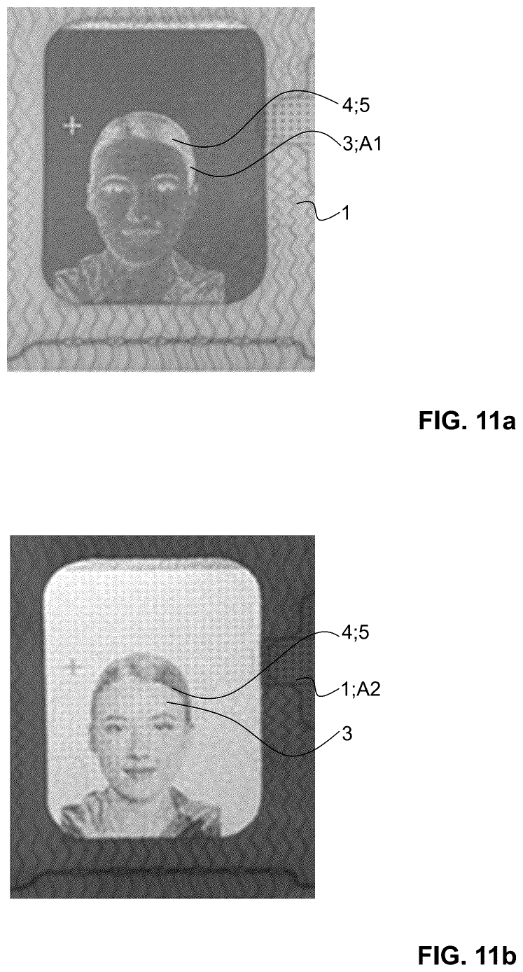

FIG. 11a illustrates the appearance A1 of the security document 1 according to FIG. 3 viewed under the first viewing angle being here at specular reflection in case of the second personalization partial element 5 being a negative laser ablation. The ablated metallic regions 7 appear dark while the remaining metallic regions appear bright.

FIG. 11b illustrates the appearance A2 of the security document 1 according to FIG. 3 viewed under a first illumination angle being here in transmission in case of the second personalization partial element 5 being a negative laser ablation. The ablated metallic regions 7 appear bright while the remaining metallic regions appear dark.

In summary it can therefore be said that a security effect provided by the personalization element 3 according to the invention is based on the change of the appearance P1, P2 of the second personalization partial element 5 being for instance a metallic layer and depending on the viewing angles α1, α2 and/or the illumination angles β1, β2. For instance, the second personalization element 5 in the form of the metallic layer looks dark at ambient light and looks bright at specular reflection. Therefore, the data given by the ablation of the metallic layer 5 will appear differently than the first personalization partial element 4 being for instance ink-jet at some viewing angles. Any forgery attempt to change the first personalization partial element 4 in the form of the print on the surface 6 of the security document 1 will not match the data which is revealed by the second personalization partial element 5 in the form of the ablated metallic layer. Since the metallic laser ablation 7 can be realized also as a negative part of the personalization element 3, no additional data can be added to the ablated pattern of the metallic layer 5. Hence, the personalization element 3 according to the present invention is associated with an increased level of security against forgery since it corresponds to a superposition of printing data such as image data being applied by the ink jet 4 on the surface 6 of the security document 1 with an appropriate pattern realized by the laser ablation 7 of the metallic layer 5.

### LIST OF REFERENCE SIGNS

1 security document
2 document body
3 personalization element
4 first personalization partial element
5 second personalization partial element
6 surface
7 radiation-treated regions
8 opaque layer
9 window
10 transparent region
11 opaque region
E extension direction
T transverse direction
α1 first viewing angle
α2 second viewing angle
β1 first illumination angle
β2 second illumination angle
P0 appearance
P1 first appearance
P2 second appearance
A1 first appearance
A2 second appearance

What is claimed, is:

1. A security document (1) such as an ID card or a passport, wherein the security document (1) extends along an extension direction (E) and comprises:
a document body (2), and
at least one personalization element (3),
wherein the personalization element (3) comprises at least a first personalization partial element (4) and at least a second personalization partial element (5),
wherein the first personalization partial element (4) and the second personalization partial element (5) are arranged at least partially above one another with respect to the extension direction (E), and
wherein the first personalization partial element (4) comprises a print, and
the second personalization partial element (5) is configured to exhibit at least a first appearance (P1) when the security document (1) is viewed under a first viewing angle (α1) and/or when the security document (1) is illuminated under a first illumination angle (β1) and to further exhibit a second appearance (P2) when the security document (1) is viewed under a second viewing angle (α2) and/or when the security document (1) is illuminated under a second illumination angle (β2) such,
that the personalization element (3) exhibits a first appearance (A1) when the security document (1) is viewed under the first viewing angle (α1) and/or when the security document (1) is illuminated under the first illumination angle (β1) and further exhibits a second appearance (A2) when the security document (1) is viewed under the second viewing angle (α2) and/or when the security document (1) is illuminated under the second illumination angle (β2).

2. The security document (1) according to claim 1, wherein the second personalization partial element (5) comprises or consist of at least one of a metallic compound, an optically variable ink, a printed patch or a coated patch, the metallic compound preferably being at least one of a metallic ink, metallic flakes or metallic particles, and/or
wherein the second personalization partial element (5) is configured to reflect incident electromagnetic radiation, and/or
wherein the second personalization partial element (5) is configured to be ablated or evaporated or bleached or color-changed upon an irradiation of electromagnetic radiation.

3. The security document (1) according to claim 1, wherein the first personalization partial element (4) corresponds to an inkjet print, a laser print, a thermal transfer print, a digital print, and/or
wherein the first personalization partial element (4) exhibits an appearance (P0) being invariant or essentially invariant under different illumination angles of the security document (1) and/or being invariant or essentially invariant under different viewing angles of the security document (1).

4. The security document (1) according to claim 1, wherein the first personalization partial element (4) is a print pattern, and/or
wherein the second personalization partial element (5) is at least one of an ablation pattern, an evaporation pattern, a bleached pattern or a color-changed pattern.

5. The security document (1) according to claim 4, wherein the print pattern and/or at least one of the ablation pattern, the evaporation pattern, the bleached pattern or the color-changed is regular, or
wherein the print pattern and/or at least one of the ablation pattern, the evaporation pattern, the bleached pattern or the color-changed is irregular.

6. The security document (1) according to claim 1, wherein the second personalization partial element (5) constitutes a binary image, or
wherein the second personalization partial element (5) constitutes a grayscale image.

7. The security document (1) according to claim 1, wherein the second personalization partial element (5) constitutes a positive part of the personalization element (3), or
wherein the second personalization partial element (5) constitutes a negative part of the personalization element (3).

8. The security document (1) according to claim 1, wherein the personalization element (3) comprises CMYK color components, and
wherein the first personalization partial element (4) provides at least one of the CMYK color components, and
wherein the second personalization partial element (5) provides at least one of the CMYK color component such as the K component.

9. The security document (1) according to claim 1, wherein the first personalization partial element (4) is provided on a surface of the document body (2) and the second personalization partial element (5) is provided within the document body (2).

10. The security document (1) according to claim 1, wherein the document body (2) comprises at least one transparent region, and wherein the personalization element (3) is at least partially arranged in the transparent region, and/or
wherein the document body (2) comprises at least one opaque region, and wherein the personalization element (3) is at least partially arranged in the opaque region and before the opaque region with respect to the extension direction (E).

11. A method of producing a security document (1) such as an ID card or a passport extending along an extension direction (E), the security document (1) preferably corresponds to the security document (1) as claimed in any one of the preceding claims, and wherein the method comprises the steps of:
Providing a document body (2), and
Providing at least one personalization element (3),
wherein the personalization element (3) comprises at least a first personalization partial element (4) and at least a second personalization partial element (5),
wherein the first personalization partial element (4) and the second personalization partial element (5) are arranged at least partially above one another with respect to the extension direction (E), and
wherein the first personalization partial element (4) comprises a print, and
the second personalization partial element (5) is configured to exhibit at least a first appearance (P1) when the security document (1) is viewed under a first viewing angle (α1) and/or when the security document (1) is illuminated under a first illumination angle (β1) and to further exhibit a second appearance (P2) when the security document (1) is viewed under a second viewing angle (α2) and/or when the security document (1) is illuminated under a second illumination angle (β2) such,
that the personalization element (3) exhibits a first appearance (A1) when the security document (1) is viewed under the first viewing angle (α1) and/or when the security document (1) is illuminated under the first illumination angle (β1) and further exhibits a second appearance (A2) when the security document (1) is viewed under the second viewing angle (α2) and/or when the security document (1) is illuminated under the second illumination angle (β2).

12. The method according to claim 11, wherein the second personalization partial element (5) is provided as a layer or foil, and/or
wherein the second personalization partial element (5) comprises or consists of at least metallic compound and/or an optically variable ink.

13. The method according to claim 11, wherein electromagnetic radiation is irradiated onto the second personalization partial element (5), whereby one or more radiation-treated regions are generated in the second personalization partial element (5), and
wherein said radiation-treated regions preferably are ablations or evaporations or bleachings or color-changes.

14. The method according to claim 11, wherein the first personalization partial element (4) is inkjet printed, laser printed, thermal transfer printed, digitally printed, and/or
wherein the first personalization partial element (4) is printed on a surface of the document body (2), and/or
wherein the second personalization partial element (5) is generated by irradiating electromagnetic radiation.

15. The method according to claim 13, wherein electromagnetic radiation of varying power is irradiated onto the second personalization partial element (5).
